(19) United States
(12) Patent Application Publication
(10) Pub. No.: US 2003/0147506 A1
(43) Pub. Date: Aug. 7, 2003

(54) Single ended line probing in DSL system using combined FDR-TDR approach

(76) Inventors: Jalil Kamali, San Jose, CA (US); Farrokh Rashid-Farrokhi, Gaithersburg, MD (US); Guozhu Long, Fremont, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 10/339,791

(22) Filed: Jan. 8, 2003

Related U.S. Application Data
(63) Continuation-in-part of application No. 09/853,048, filed on May 9, 2001.
(60) Provisional application No. 60/357,408, filed on Feb. 15, 2002.

(51) Int. Cl. H04M 1/24; H04M 3/08; H04M 3/22

(52) U.S. Cl. 379/22.02; 379/1.04

(57) ABSTRACT

A Single Ended Line Probing (SELP) technique using combined Frequency Domain Reflectometry (FDR) and Time Domain Reflectometry (TDR) for characterizing a transmission medium (e.g., DSL) is disclosed. FDR is used to detect one or more reflectors (e.g., short, load coil, bridge tap) in the transmission medium. TDR is then used to determine the location of the reflectors in the transmission medium. In one embodiment, a wide band periodic probing signal is used to probe the transmission medium for reflectors. In another embodiment, gauge information can be used to increase the valid range of the combined FDR/TDR SELP technique.

### CROSS-REFERENCE TO RELATED APPLICATIONS

This application claims the benefit of U.S. Provisional Application No. 60/357,408, filed Feb. 15, 2002, and is a continuation-in-part of U.S. patent application Ser. No. 09/853,048, filed May 9, 2001. Each of these applications is incorporated by reference herein.

### BACKGROUND

1. Field of the Invention

The present invention is related to the field of telecommunications, and in particular, to a single ended line probing (SELP) technique for Digital Subscriber Line (DSL) systems.

2. Background

DSL communications use copper telephone lines (e.g., twisted pair) for high-speed data transmission. A major problem for DSL service providers is to accurately qualify a subscriber's local loop (sometimes referred to as “probing the line”) prior to the deployment of DSL service. In general, line probing involves measuring line parameters such as loop capacitance and loop resistance. A typical approach for probing the line requires a first handset to be attached to the telephone line at the telephone company's Central Office (CO) location and a second handset to be attached to the telephone line at the customer premises equipment (CPE) location. Thus, human interaction is required at two points of the telephone line, including a service call to the CPE location, which increases the cost of deployment.

SELP is a technique that eliminates the need for a service call to the CPE location and the additional costs of such service. Time Domain Reflectometry (TDR) is a SELP technique whereby a pulse is transmitted across a transmission medium (e.g., DSL) and the reflected pulse is examined to identify the characteristics of the transmission medium. A fundamental limitation of TDR lies in the fact that reflections from far reflectors (e.g., end-of-long loops, end-of-far bridge-taps (B/T), load coils, shorts) can be attenuated to an unobservable state. Moreover, if there are reflecting elements close to each other, their respective reflections overlap with each other thereby making it difficult to differentiate between those reflections. A third dilemma arises because the only information that a reflection contains is its sign. That is, a reflection can have the same sign of the original pulse or the opposite sign. The reflections from a hard reflector (e.g., load coil, end-of-line, end-of-B/T) have the same sign as the original pulse, and reflections from a soft reflector (e.g., short or B/T) have the opposite sign. As such, a B/T is hard to distinguish from a short by analyzing the reflected pulse. Likewise, a load coil, an end-of-line, and an end-of-B/T are hard to distinguish from one another.

Due to such restricting factors, TDR-based line probing techniques are incapable of fully characterizing an unknown line, and at best can present the reflected pulse to the operator (e.g., Sunrise handset). On the other hand, Frequency Domain Reflectometry (FDR) based SELP, can be employed to determine whether there is a short or load coil on the line. If there is no short or load coil on the line, FDR can estimate the loop length as explained in U.S. patent application Ser. No. 09/853,048, entitled “Single Ended Line Probing in DSL System.” The FDR technique, however, is unable to estimate the location of shorts or load coils in the transmission medium.

Accordingly, there is a need for a SELP technique that allows a more comprehensive characterization of a transmission medium by considering not only various types of reflectors, but also their location on the transmission medium.

### SUMMARY OF THE INVENTION

The present invention is directed to a SELP system and method that combines FDR and TDR techniques. FDR-SELP is used to detect one or more reflectors (e.g., short, load coil, bridge tap) in a transmission medium (e.g., DSL), then TDR-SELP is used to determine the location of the reflectors in the transmission medium.

A method of estimating the length of a transmission medium using SELP comprises the steps of: probing the transmission medium with a probe signal; receiving a reflected version of the probe signal; determining if a reflector is present in the transmission medium using FDR; and responsive to a determination that a reflector is present in the transmission medium, determining the location of the reflector in the transmission medium using TDR.

A system for estimating the length of a transmission medium using SELP comprises: a transmitter adapted to be coupled to the transmission medium for probing the transmission medium with a probe signal; a processor coupled to the transmitter and adapted for processing a reflected version of the probe signal to determine if a reflector is present in the transmission medium using FDR; and responsive to a determination that a reflector is present in the transmission medium, using TDR to determine the location of the reflector in the transmission medium.

### BRIEF DESCRIPTION OF THE DRAWINGS

FIG. 1 is a block diagram of a DSL modem for performing FDR-TDR SELP, in accordance with an embodiment of the present invention.

FIG. 2 is a flow diagram of an FDR/TDR-based SELP technique, in accordance with an embodiment of the present invention.

FIGS. 3A-3C are diagrams illustrating various conditions that can be encountered on a transmission line.

FIGS. 4A and 5B are graphs illustrating a transmitted pulse and reflected pulse, in accordance with an embodiment of the present invention.

FIGS. 5A and 5B are graphs, illustrating cross-correlation functions of transmitted and received pulses, respectively, in accordance with an embodiment of the present invention.

### DETAILED DESCRIPTION OF EMBODIMENTS

The SELP technique described herein uses the results of FDR-based SELP (hereinafter also referred to as “FDR-SELP”) as apriori knowledge of a transmission line for TDR-based SELP (hereinafter also referred to as “TDR-SELP”). A full characterization of the transmission line is thus enabled. For instance, if FDR-SELP detects a short in the line, TDR-SELP will know the negative reflection is due to a short (as opposed to a B/T), and thus can estimate the location of the short. Similarly, FDR-SELP can detect a load coil and then TDR-SELP can find its location. In this case, detection made by FDR indicates that the positive reflection comes from a load coil and not the end-of-line or end-of-B/T. In general, by combining information gathered by FDR-SELP and TDR-SELP, the transmission line (e.g. DSL subscriber loop) can be configured based on characteristics identified by each SELP technique.

### DSL Modem With SELP MODE

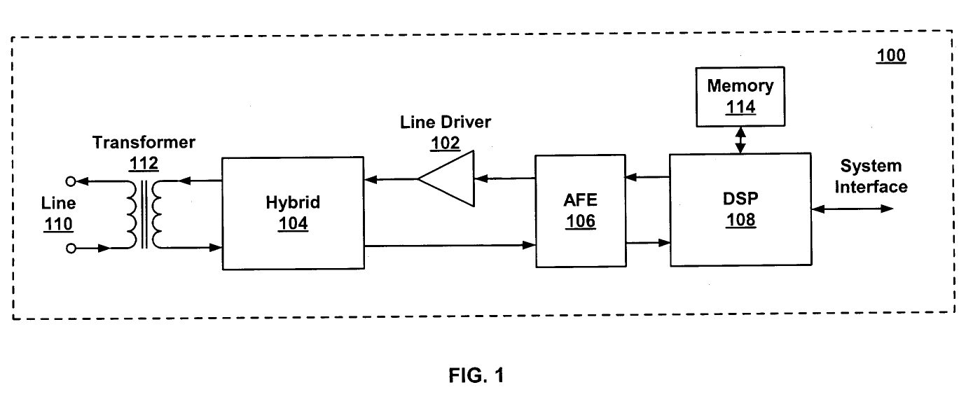

Referring to FIG. 1, there is shown a DSL modem 100 for performing FDR-TDR SELP, in accordance with an embodiment of the present invention. Modem 100 may be one of a number of modems included on a multiple port assembly (e.g., a line card having 48 individual modems and corresponding ports). Alternatively, modem 100 may be a stand-alone modem. Modem 100 includes transformer 112, hybrid 104, line driver 102, analog front end (AFE) 106, and digital signal processor (DSP) 108. Transformer 112 is coupled to line 110, while the DSP 108 is coupled to a system interface (e.g., ATM network).

Transformer 112 couples the line 110 to the circuitry of modem 100 and provides electrical isolation between line 110 and the modem 100 electronics and network. The turns ratio of transformer 112 is 1:n, where the value of n depends on factors such as the desired line voltage and the specifications of the components included in modem 100. In one embodiment, transformer 112 is configured to allow low frequency access to line 110 when operating in FDR-SELP mode. In an alternative embodiment, transformer 112 includes a switchable high pass filtering mechanism that can be enabled and disabled depending on the mode of operation. In data mode, the high pass filtering mechanism is enabled thereby removing undesirable low frequency signals from the DSL band. In the FDR-SELP mode, however, the high pass filtering mechanism is disabled thereby allowing low frequency line probing signals access to and from the DSL band. Since the use of low frequency signals is not required for TDR-SELP, the transformer 112 does not need to be specially configured or employ a switchable high pass filtering mechanism to pass low frequency signals when operating in TDR-SELP mode.

Hybrid 104 performs 2-to-4-wire conversion, which converts the bi-directional two-wire signal from the telephone line into two pairs of one-directional transmissions. One pair is for receiving and the other pair is for transmitting. In one embodiment, hybrid 104 is configured to allow low frequency access to and from line 110. In another embodiment, a splitter (e.g., for isolating DSL data and POTS data) is operatively coupled to transformer 112 on the line side. In such an embodiment, the splitter can be switched in or out. For example, when the modem 100 is operating in data mode, the splitter is switched in thereby removing undesired signals (e.g., POTS signals) from the DSL transmission band. On the other hand, when the modem 100 is operating in FDR-SELP mode, the splitter is switched out thereby allowing low frequency probing signals access to and from the line 110.

AFE 106 typically includes an analog-to-digital (A/D) converter and a digital-to-analog (D/A) converter. The separated signal received by AFE 106 from hybrid 104 is converted from analog to digital by the A/D converter and is provided to DSP 108. AFE 106 may further comprise a gain adjust module for optimizing the signal sent to DSP 108. With regards to the transmit direction, data received from the system interface is processed by DSP 108. Such data might be from a customer's data terminal equipment or from the telephone company's network. The digital output of DSP 108 is converted to its analog equivalent by the D/A converter in AFE 106.

The output of AFE 106 is provided to line driver 102. In one embodiment, line driver 102 is configured to allow low frequency access to line 110 when operating in FDR-SELP mode. In alternative embodiment, line driver 102 includes a switchable high pass filtering mechanism that can be enabled and disabled depending on the mode of operation (e.g., FDR, TDR). In data mode, the high pass filtering mechanism is enabled thereby removing undesirable low frequency signals from the DSL band. In FDR-SELP mode, however, the high pass filtering mechanism is disabled thereby removing allowing low frequency signals access to line 110. Again, since the use of low frequency signals is not required for TDR-SELP, the line driver 102 does not need to be specially configured or employ a switchable high pass filtering mechanism to pass low frequency signals when operating in TDR-SELP mode.

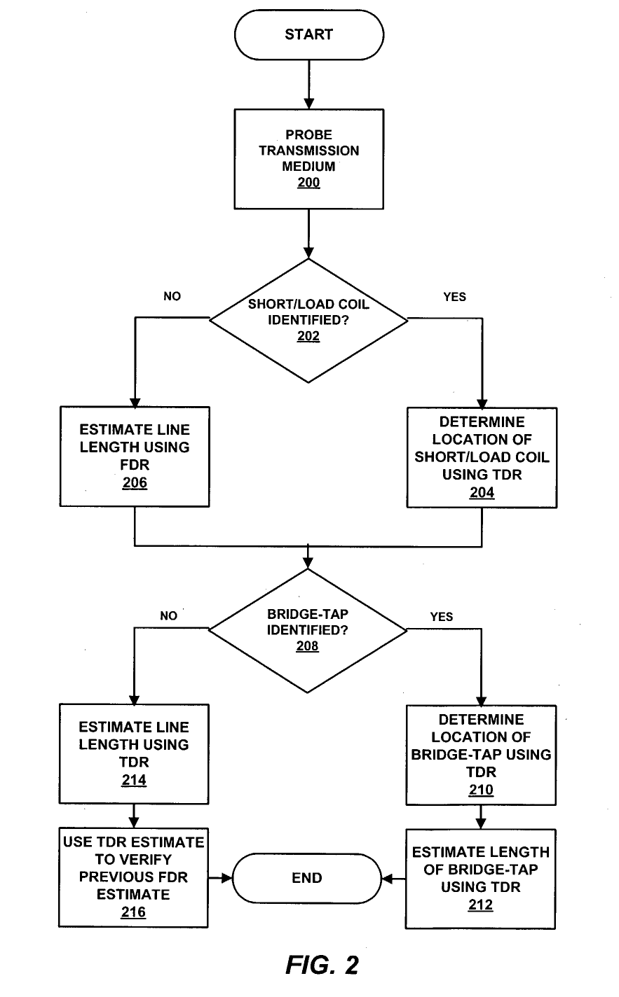

In the embodiment shown, DSP 108 executes a line probing process in accordance with the present invention. The functionality of this line probing process will be discussed in more detail with reference to FIG. 2. DSP 108 may also perform a number of other functions. For example, DSP 108 can be used or programmed to perform modulation, coding, error detection, and other algorithm-based functions.

During FDR and TDR SELP modes, line probing signals may be transmitted onto line 110 by modem 100. In one embodiment, samples of the transmitted line probing signals can be kept in a storage device (e.g., EEPROM or other memory device), which is accessible by DSP 108. Upon receiving a request to initiate a line probing sequence, DSP 108 can access the samples from storage and provide them to AFE 106 for conversion to analog form. Alternatively, a programmable signal generator (not shown) can be triggered by DSP 108 to provide the line probing signals. DSP 108 can then provide supplied probing signals to AFE 106 for conversion to analog form. Regardless of the source of the probing signals, their analog equivalent are driven onto line 110 by line driver 102 by way of hybrid 104 and transformer 112.

The transmitted probing signals are reflected back to modem 100. The reflected signals are decoupled from the line 110 by transformer 112 and provided to DSP 108 by way of hybrid 104 and AFE 106. In such an embodiment, hybrid 104 is configured for both data mode and SELP mode (e.g., allows for low frequency access to and from line 110 when operating in FDR-SELP mode). Alternatively, hybrid 104 is effectively bypassed to perform line probing when operating in FDR-SELP mode. In one embodiment, a port at the modem side of transformer 112 is coupled directly to AFE 106. In such an embodiment, modem 100 can be dedicated to a line probing function that operates in accordance with the principles of the present invention.

Based on the transmitted and received line probing signals, DSP 108 (or its equivalent) can then measure the transfer function of the line 110. Note that in alternative embodiments, DSP 108 can be replaced by, for example, an ASIC or chip set, or a combination of a DSP and an ASIC, or other equivalent combinations (e.g., a DSP operatively coupled to a signal generator and network analyzer adapted to provide the transmitted probing signals and measure the transfer function of the line based on the transmitted and reflected probing signals). DSP 108 may be integrated with the modem 100, or may be operatively coupled to the modem 100 (e.g., via one or more external port connections). Generally, DSP 108 analyzes the transmitted and reflected probing signals thereby providing information to qualify the line. Qualifying the line may include, for example, measuring the loop length, determining if a short is present, determining if load coils are present, and if so, how many.

### FDR/TDR SELP Process

Referring to FIG. 2, there is shown is a flow diagram of an FDR/TDR SELP process, in accordance with an embodiment of the present invention. The line information obtained from FDR-SELP is used to make optimum use of information obtained from TDR-SELP. The process can be carried out, for example, by software instructions located on a computer-readable medium (e.g., memory 114) executed by a processor (e.g., DSP 108). Any FDR techniques can be used with the present invention, such as the FDR techniques described in U.S. application Ser. No. 09/853,048, filed May 9, 2001. Any TDR techniques can be used with the present invention, such as the TDR technique described in U.S. Pat. No. 5,461,318, entitled “Apparatus and Method for Improving A Time Domain Reflectometer,” issued Oct. 24, 1995, which is incorporated by reference herein.

The FDR/TDR SELP process starts by probing 200 the transmission line 110 with a probe signal and measuring a reflected version of the probe signal to determine the presence of one or more load coils and/or shorts in the transmission line using FDR. If a short or load coil is identified 202, then TDR is used to determine 204 the location of the load coil or short in the transmission line. FDR can detect up to three load coils whose locations can be found by TDR. Moreover, the placement of load coils in the United States follows industry guidelines and is well known (i.e., every six Kft for a loop longer than 9 Kft). If no load coils or shorts are identified 202, then FDR is used to estimate 206 the length of the transmission line. The transmission line is then tested for the presence of a bridge-tap using TDR. If a bridge-tap is identified 208, then TDR is used to determine 210 the location of the bridge-tap in the transmission line and to estimate 212 its length. If no bridge-tap is detected 208, then TDR is used to estimate 214 the length of the transmission line and use this estimate to verify 216 the length of the transmission line previously estimated 206 using FDR.

As the number of bridge-taps increases and the locations of the bridge-taps get further from the Central Office (CO), the identification of bridge-taps in the transmission medium becomes more difficult. Typically, the number of bridge-taps rarely exceeds one in a given telephone line. Since FDR is capable of measuring the total length of the transmission medium (including all bridge-taps), information obtained through FDR can be used to resolve the ambiguity in most cases.

### TDR Implementation

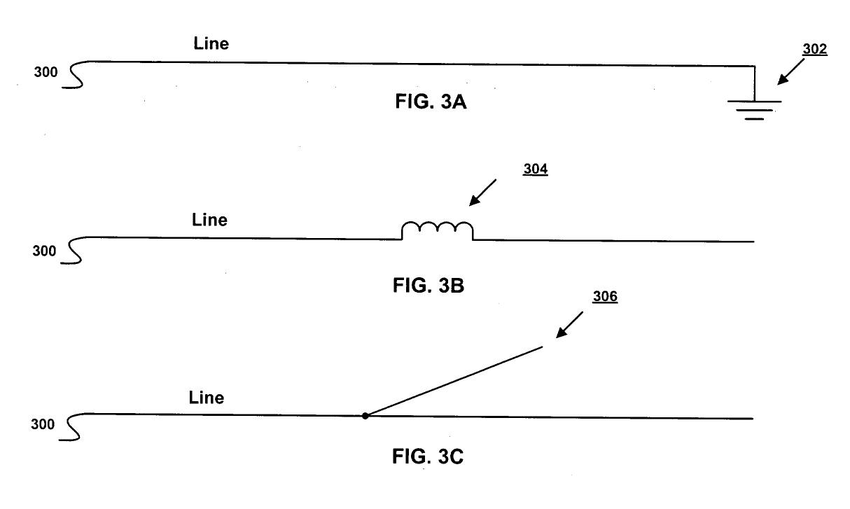

TDR-SELP will now be discussed. In one embodiment, TDR-SELP utilizes a pulse transmission. Once the transmitted pulse is reflected back to the transmitting node, a cross correlation function between the transmitted and received pulse is calculated and examined for reflectors. FIGS. 3A-3C illustrate various conditions that can be encountered on a transmission line 300 (sometimes referred to as a loop, twisted pair, or channel). In particular, a short 302 is illustrated in FIG. 3A, a load coil 304 in FIG. 3B, and a bridge-tap 306 in FIG. 3C.

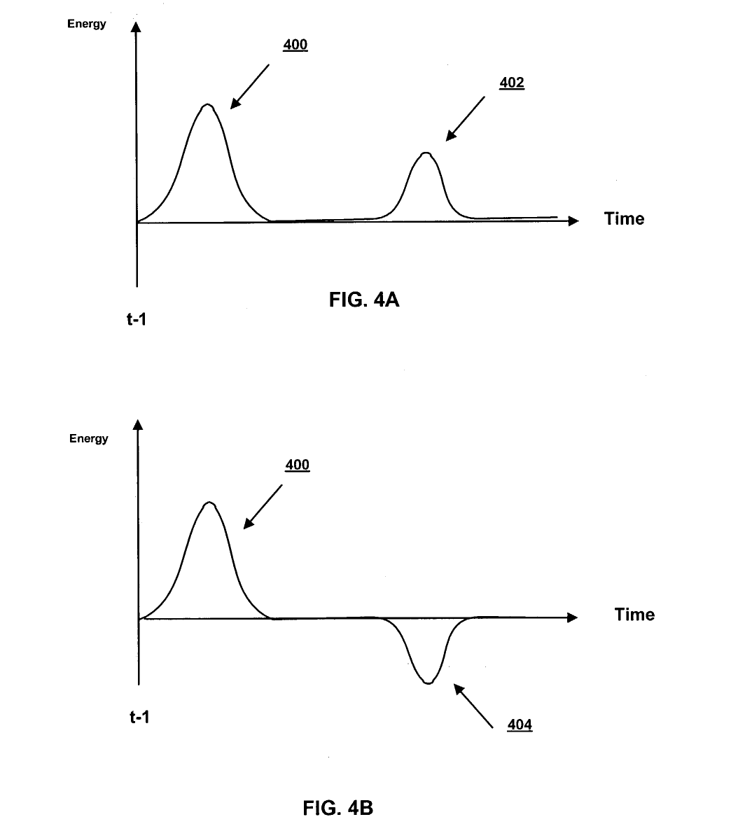

Referring to FIGS. 4A and 4B, there are shown graphs illustrating a transmitted pulse 400 and reflected pulses 402, 404, in accordance with one embodiment of the present invention. As can be seen in FIG. 4A, a positive reflected pulse 402 is indicative of a load coil, an end-of-bridge-tap, or an end-of-line in the transmission medium. FIG. 4B shows how a negative reflected pulse 404 is indicative of a short or a bridge tap in the transmission medium. Note that the signals indicated in FIGS. 4A and 4B are not to scale. In reality, the reflected pulse 402 is significantly smaller in amplitude than the transmitted pulse 400. In addition, the time-axis in the graphs is set to start at t−1 (time just before the original pulse is transmitted, which is t₀), to visually illustrate the positive/negative relationship between the transmitted pulse 400 and the reflected pulse 402.

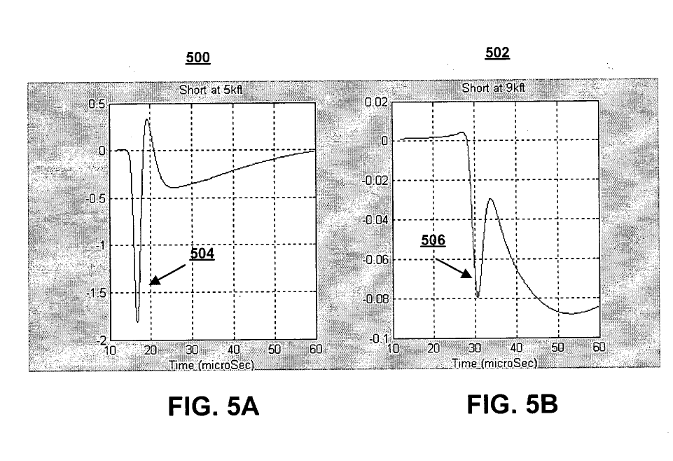

Referring to FIGS. 5A and 5B, there are shown two graphs illustrating cross-correlation functions 500, 502 of a transmitted pulse and received pulse, respectively, in accordance with one embodiment of the present invention. In these particular cases, there is a short circuit at 5000 feet and 9000 feet from the CO, respectively. In both cases, the dips 504, 506, in the cross correlation functions are associated with the location of the short.

In some cases, the TDR information can be obtained from the channel impulse response. In these cases, the overall channel impulse response (including the channel and all the modem circuitry, such as the hybrid, transformer and filters) is calculated from the cross correlation functions 500, 502. Conventional de-convolution methods can then be used to effectively remove the modem circuitry from the overall impulse response to identify the impulse response of the channel only. To avoid de-convolution, a modem configured to operate in SELP mode can be used, where the likes of the hybrid, transmit/receive filters, and transformer are bypassed or otherwise removed thereby eliminating their impact on the overall channel response.

The TDR-SELP implementation described above introduces further practical considerations. Transmitters typically have limitations on the maximum power transmitted. For example, a narrow square probe signal has a high Peak-to-Average Ratio (PAR), which reduces the average power the transmitter can transmit. As such, the resolution of TDR-SELP may be reduced in the presence of noise. In an alternative embodiment, a wide band periodic probing signal or a spreading sequence is transmitted (instead of a square pulse) that is specially designed to have a lower PAR and impulse-like auto-correlation function. Such a signal is described in Guozhu Long & Fuyun Ling, “Fast Initialization of Data-Driven Nyquist In-Band Echo Cancellers,” IEEE Transactions On Communications, Vol. 41, No. 6, pp. 893-904, June 1993.

As long as the period of such a periodic probing signal is longer than the overall channel impulse response, the cross-correlation of a period of this probing signal with its reflection from the channel is a good estimate of the reflection channel impulse response. In addition, with this alternative approach, it is possible to capture the on-board circuit (e.g., modem) characteristics in the signal design. As such, an appropriate transmit signal shape can be provided that has little or no energy in the frequencies that are rejected by filters on the board so that the variations in these filters have negligible effect on the measurement accuracy.

As previously explained, the FDR-SELP technique can detect reflectors (e.g., load coil, short) and estimate the length of the transmission medium having various wire gauges. If the gauge of the transmission medium is known, the valid range of the algorithm can be increased enabling the accurate detection of shorts, load coils, or bridge-tap that are physically located further from the CO. If the wire gauge is known, a pre-established impulse response (e.g., established based on empirical data or previously measured) of a long loop with that gauge is subtracted from the measured impulse response. The difference can then be examined for the existence of reflectors that might otherwise be hidden or overshadowed by the transmitted pulse thereby improving the accuracy of the algorithm.

The above description is included to illustrate the operation of the preferred embodiments and is not meant to limit the scope of the invention. Rather, the scope of the invention is to be limited only by the claims. From the above discussion, many variations will be apparent to one skilled in the relevant art that would yet be encompassed by the spirit and scope of the invention.

What is claimed is:

1. A method of estimating a length of a transmission medium using Single Ended Line Probing (SELP), the method comprising the steps of:
probing the transmission medium with a probe signal;
receiving a reflected version of the probe signal;
determining if a reflector is present in the transmission medium using Frequency Domain Reflectometry (FDR); and responsive to a determination that a reflector is present in the transmission medium,
determining the location of the reflector in the transmission medium using Time Domain Reflectometry (TDR).

2. The method of claim 1, further comprising:
estimating the length of the transmission medium using FDR if a reflector is not present in the transmission medium.

3. The method of claim 1, further comprising:
confirming the estimated length of the transmission medium determined by FDR using TDR.

4. The method of claim 1, wherein a wide band periodic probing signal is used to probe the transmission medium.

5. The method of claim 1, wherein the transmission medium is a telephone line and the gauge of the telephone line is used to determine the location of the reflector.

6. A system for estimating a length of a transmission medium using Single Ended Line Probing (SELP), the system comprising:
a transmitter adapted to be coupled to the transmission medium for probing the transmission medium with a probe signal;
a processor coupled to the transmitter and adapted for processing a reflected version of the probe signal to determine if a reflector is coupled to the transmission medium using Frequency Domain Reflectometry (FDR); and responsive to a determination that a reflector is present in the transmission medium, using Time Domain Reflectometry (TDR) to determine the location of the reflector in the transmission medium.

7. The system of claim 6, wherein the processor estimates the length of the transmission medium using FDR if a reflector is not present in the transmission medium.

8. The system of claim 6, wherein a wide band periodic probing signal is used to probe the transmission medium.

9. The system of claim 6, wherein the transmission medium is a telephone line and the gauge of the telephone line is used to determine the location of the reflector.

10. The system of claim 6, wherein the reflector is from a group of reflectors comprising shorts, load coils and bridge-taps.

11. A computer-readable medium having instructions contained thereon, which, when executed by a processor in a Single Ended Line Probing (SELP) device, perform the operations of:
configuring a transmitter in the SELP device to probe a transmission medium with a probe signal and process a reflected version of the probe signal to determine if a reflector is present in the transmission medium using Frequency Domain Reflectometry (FDR); and responsive to a determination that a reflector is present in the transmission medium, using Time Domain Reflectometry (TDR) to determine the location of the reflector in the transmission medium.

12. A system for estimating the length of a transmission medium using Single Ended Line Probing (SELP), comprising:
means for probing the transmission medium with a probe signal;
means for receiving a reflected version of the probe signal;
means for determining if a reflector is present in the transmission medium using Frequency Domain Reflectometry (FDR); and responsive to a determination that a reflector is present in the transmission medium,
means for determining the location of the reflector in the transmission medium using Time Domain Reflectometry (TDR).

13. A processor for use in a Digital Subscriber Line (DSL) modem, comprising:
memory adapted for storing computer program code, the computer program code including instructions for processing a reflected version of a probe signal received from a transmission medium to determine if a reflector is present in the transmission medium using Frequency Domain Reflectometry (FDR), and responsive to a determination that a reflector is present in the transmission medium, using Time Domain Reflectometry (TDR) to determine the location of the reflector in the transmission medium; and
circuitry for executing the computer program code.
